(19) United States
(12) Patent Application Publication
(10) Pub. No.: US 2013/0246232 A1
(43) Pub. Date: Sep. 19, 2013

(54) APPLYING SUMS IN TRANSACTION PROCESSING

(71) Applicants: Marjorie A. Swanson, Fargo, ND (US); Joseph A. Pytlik, Fargo, ND (US); Theresa M. Nistler, Fargo, ND (US)

(72) Inventors: Marjorie A. Swanson, Fargo, ND (US); Joseph A. Pytlik, Fargo, ND (US); Theresa M. Nistler, Fargo, ND (US)

(73) Assignee: Microsoft Corporation, Redmond, WA (US)

(21) Appl. No.: 13/539,512

(22) Filed: Jul. 2, 2012

Related U.S. Application Data
(60) Provisional application No. 61/611,392, filed on Mar. 15, 2012.

(51) Int. Cl. G06Q 40/00

(52) U.S. Cl. 705/30

(57) ABSTRACT

A prepayment is tied to a purchase order when a purchase order is generated. The prepayment is then posted to a deferred payment account, instead of an accounts payable account. When an invoice is received on the purchase order, the prepayment is applied to the invoice. The prepayment is consumed before increasing the accounts payable account.

The present application is based on and claims the benefit of U.S. provisional patent application Ser. No. 61/611,392, filed Mar. 15, 2012, the content of which is hereby incorporated by reference in its entirety.

### BACKGROUND

Where two companies are interacting with one another, it can be difficult to track their interactions. That is, where a company places an order with a vendor, it can be difficult to accurately characterize the transaction.

More specifically, in some financial software, the functionality provided does not properly handle a situation where a company wants to make a prepayment for goods or services prior to processing a purchase order. In addition, it is difficult to enter a prepayment to a vendor and have it tied to the purchase order that is being placed. Similarly, current financial software does not provide the ability to apply that prepayment to an invoice when the goods are invoiced in a purchase order processing (POP) environment.

One way of addressing this issue is to enter a payment through a separate, payables management (PM) module as a prepayment for goods on a purchase order. However, in that scenario, an accounts payable account is incorrectly stated. That is, it appears in the account like less is currently owed to vendors because the prepayment is not recognized as a deferred prepayment.

For example, some customers handle prepayments in their financial software as follows: A user creates a payment of $100,000.00 to Vendor B as a prepayment. The company already owes Vendor A $100,000.00 for a separate order. According to the balance sheet, there is zero accounts payable liability when in fact the company still owes Vendor A $100,000.00. The $100,000.00 prepaid to Vendor B should be a deferred charge (a balance sheet asset) and not a prepaid liability. There is currently no way to tie this payment to the purchase order or to a shipment/invoice in the POP module when the goods are received.

The volume of prepayments on purchase orders can be particularly problematic when using vendors in certain geographic areas. For instance, vendors from the Pacific Rim typically have a customer provide at least some payment prior to processing the purchase order. The amount can vary, but in many cases it is 50 percent of the total order cost.

Another reason that prepayments are sometimes asked of customers is that a customer may have a poor credit rating. In that case, a vendor may require partial or full payment in order to process the purchase order.

The problem of processing prepayments can be exacerbated based on the size of the company making the payment. A small customer is more likely to have one person (such as a bookkeeper) completing both the purchasing and the accounts payable processes. However, a larger organization is more likely to split those roles between a purchasing agent and an accounts payable user, making it even more difficult to accurately track prepayments.

The discussion above is merely provided for general background information and is not intended to be used as an aid in determining the scope of the claimed subject matter.

### SUMMARY

A prepayment is tied to a purchase order when a purchase order is generated. The prepayment is then posted to a deferred payment account, instead of an accounts payable account. When an invoice is received on the purchase order, the prepayment is applied to the invoice. The prepayment is consumed before increasing the accounts payable account.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one illustrative business system.

FIG. 2 is a flow diagram illustrating one embodiment of the operation of the system shown in FIG. 1 in generating and sending a purchase order with a prepayment.

FIGS. 2A-2I are exemplary user interface displays.

FIG. 3 is a flow diagram illustrating one illustrative operation of the system shown in FIG. 1 in processing a shipment or invoice.

FIGS. 3A-3D are illustrative user interface displays.

FIG. 4 is a block diagram showing various architectures.

FIGS. 5-9 illustrate various embodiments of mobile devices.

FIG. 10 is a block diagram of one illustrative computing environment.

### DETAILED DESCRIPTION

As discussed herein, a prepayment is an expenditure for a future benefit. A prepayment can be recorded in a balance sheet asset account referred to herein as a deferred charge. It can then be written off in the period when the benefit is enjoyed.

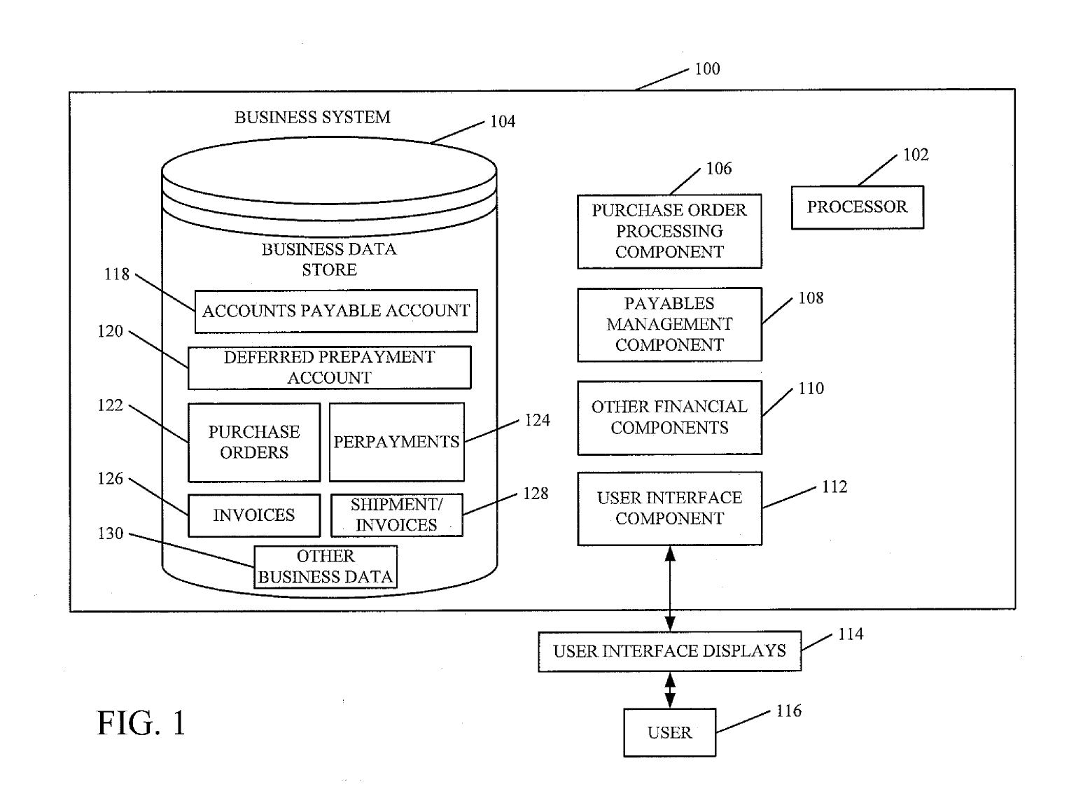

FIG. 1 shows a block diagram of one illustrative business system 100. Business system 100 illustratively includes processor 102, business data store 104, purchase order processing component 106, payables management component 108, other financial components 110, and user interface component 112. In the embodiment discussed herein, user interface component 112 generates user interface displays 114 that are displayed to user 116. Displays 114 also include user input mechanisms that receive user inputs from user 116, and allow user 116 to control business system 100.

Processor 102 is illustratively a computer processor with associated memory and timing circuitry (not shown). Processor 102 is illustratively a functional component of business system 110 and is activated by other components in business system 100 to facilitate the functionality of those components.

In the embodiment shown in FIG. 1, business data store 104 includes a wide variety of business data. The data can include, for example, an accounts payable account 118, a deferred prepayment account 120, one or more purchase orders 122, one or more prepayment records 124, invoices 126, shipment or invoice records indicating shipments/invoices 128 and other business data 130.

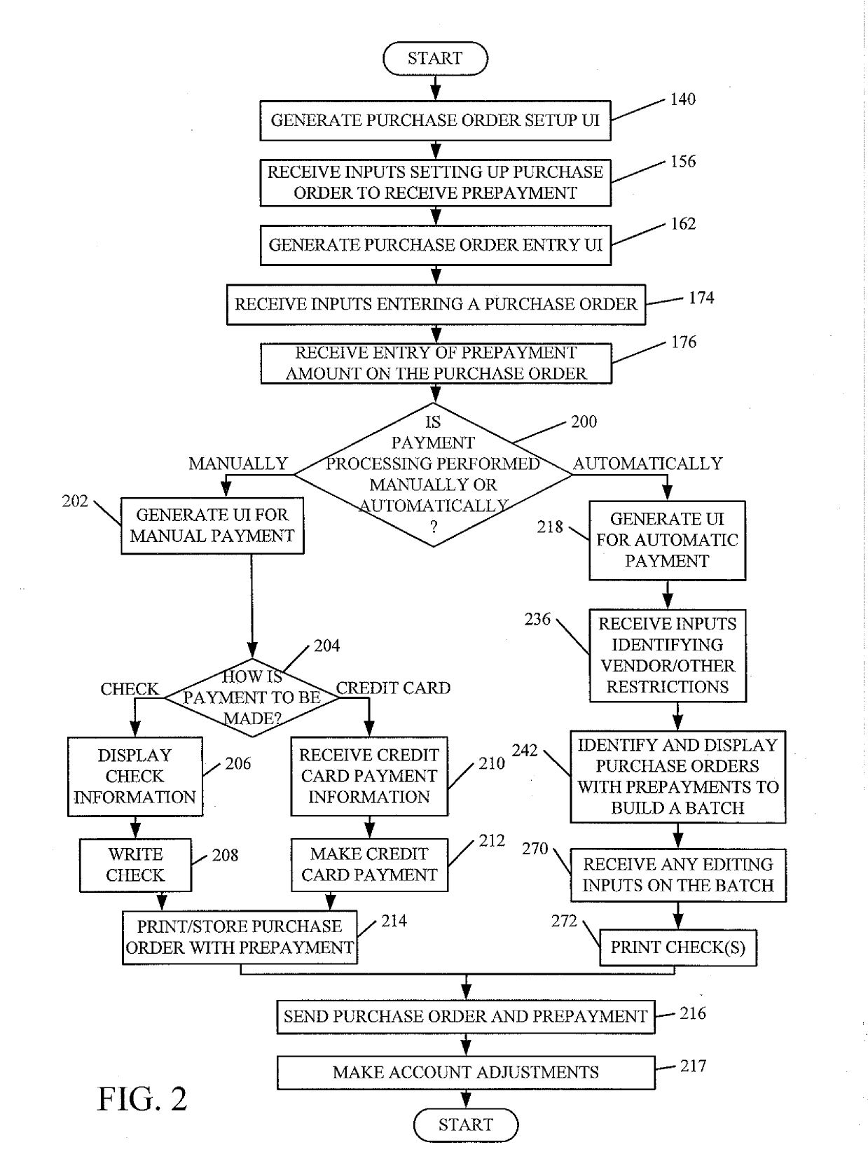

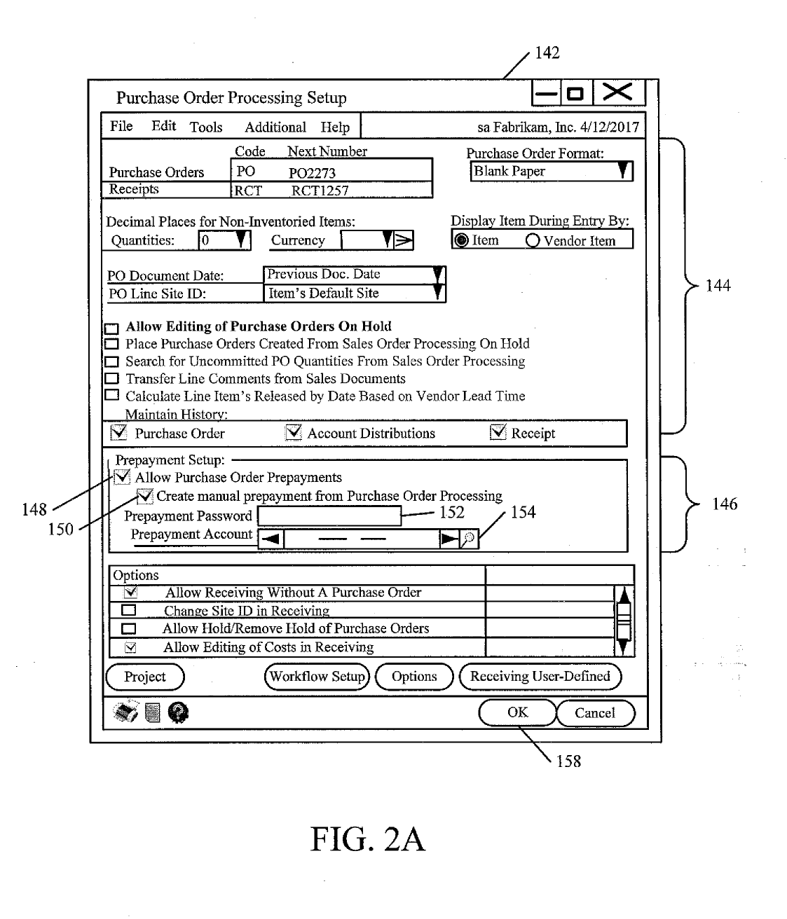

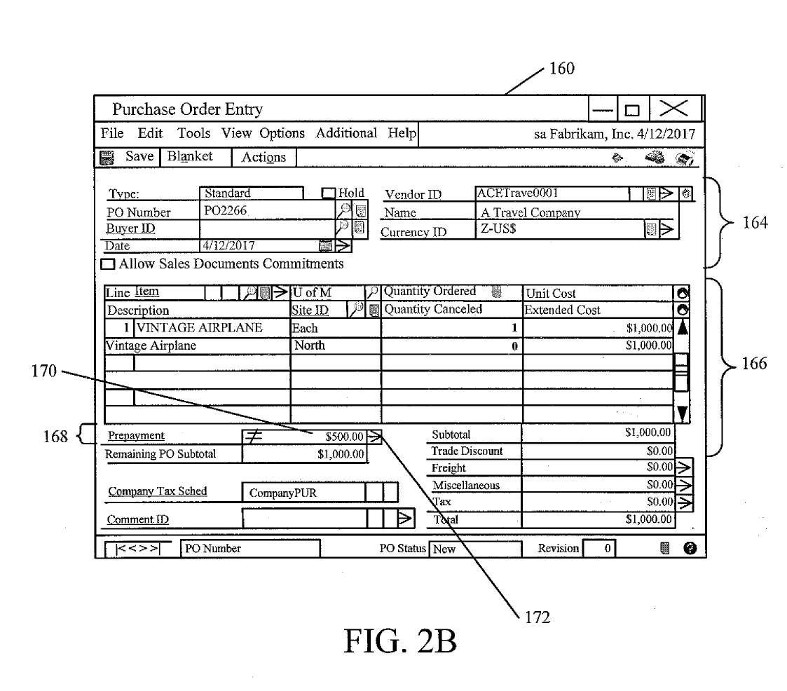

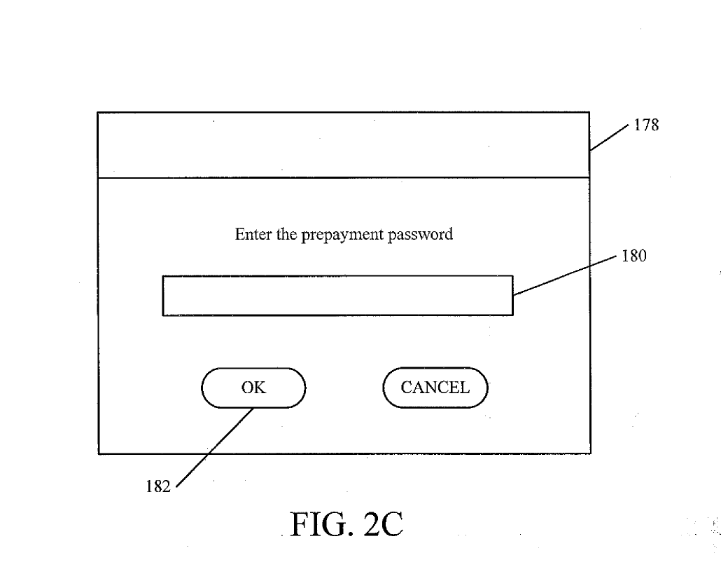

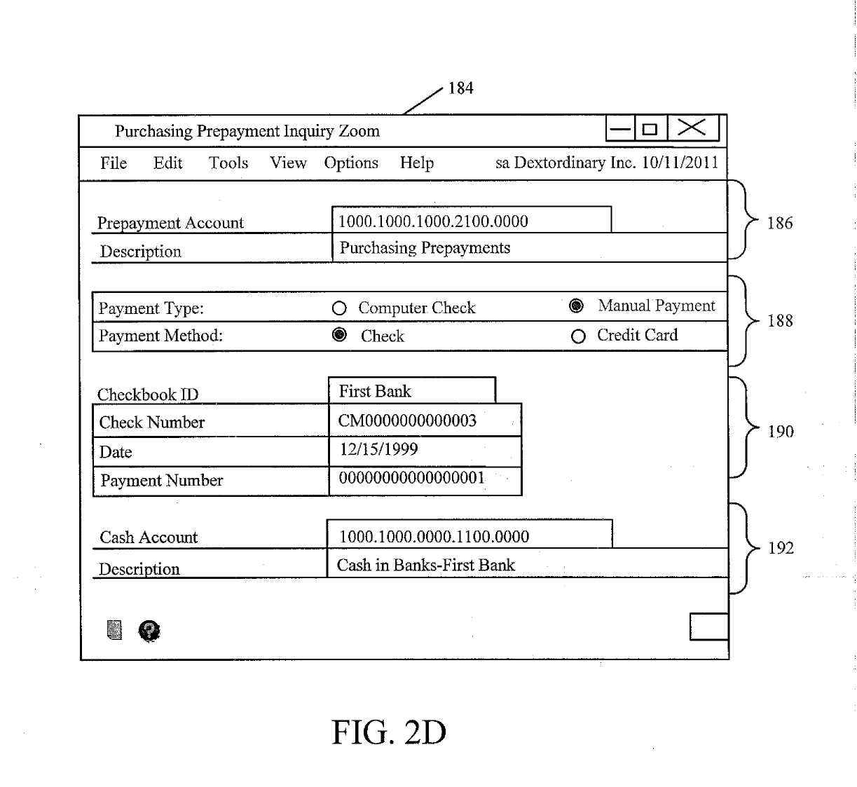

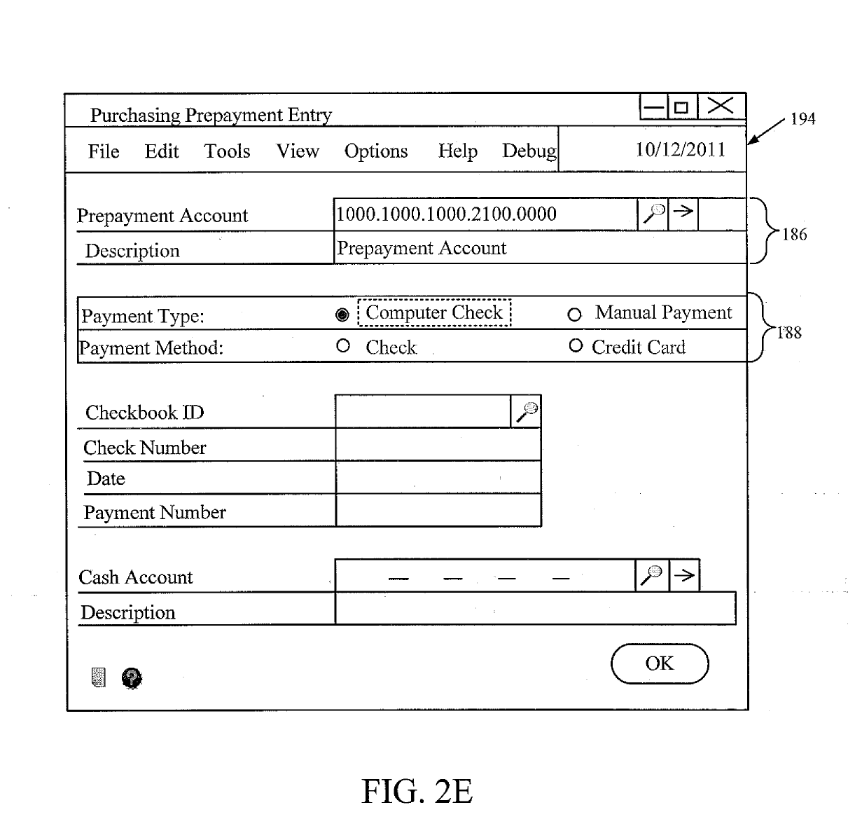

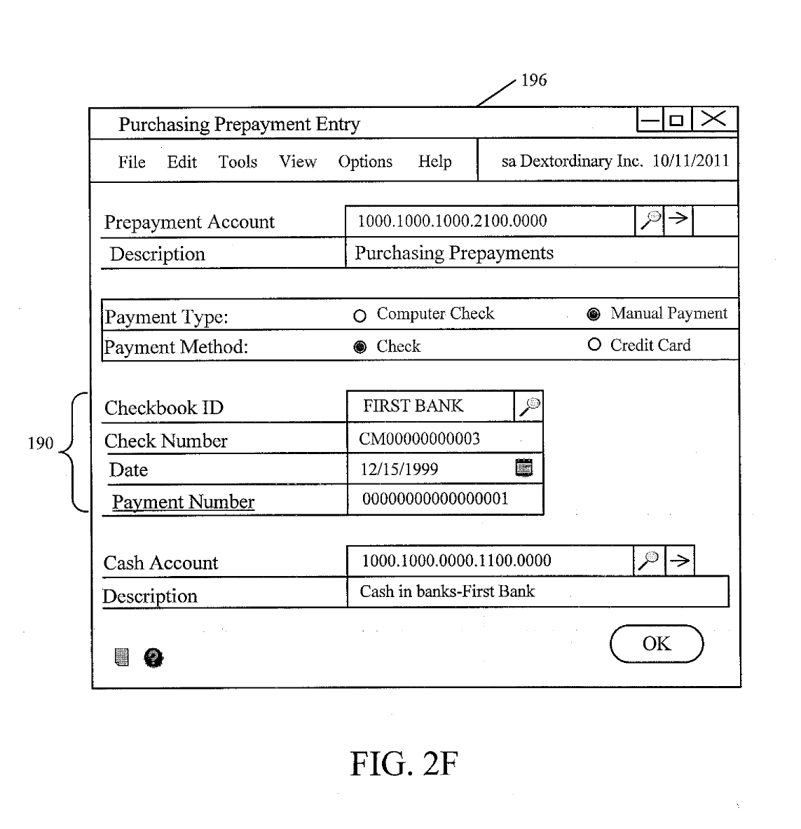

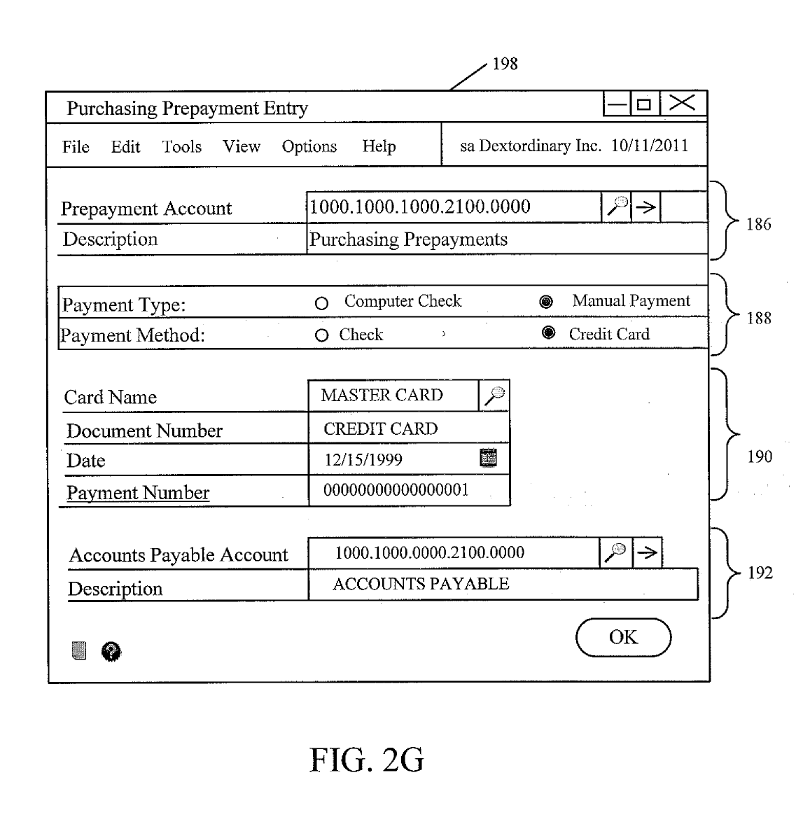

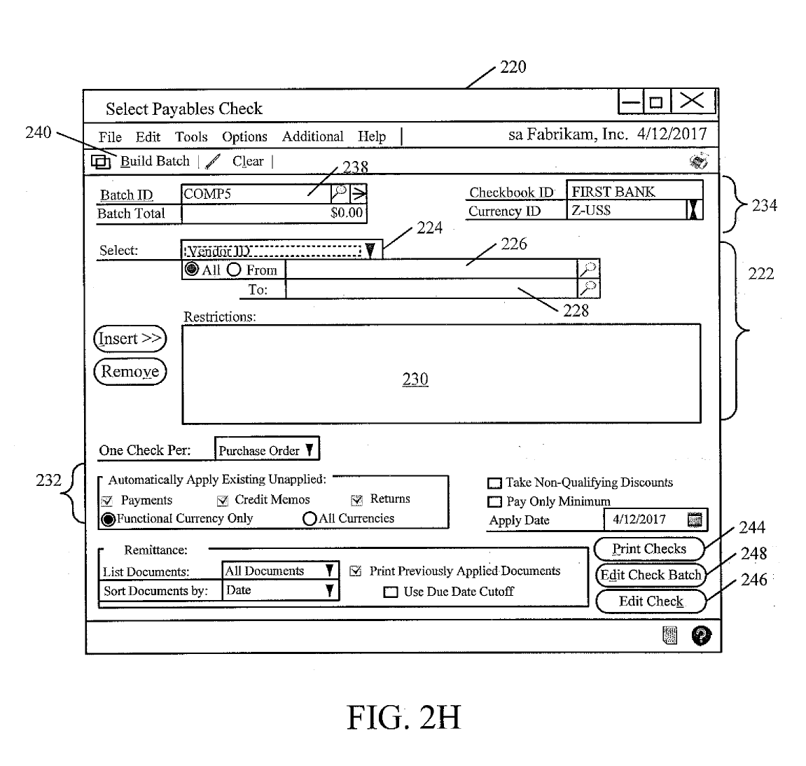

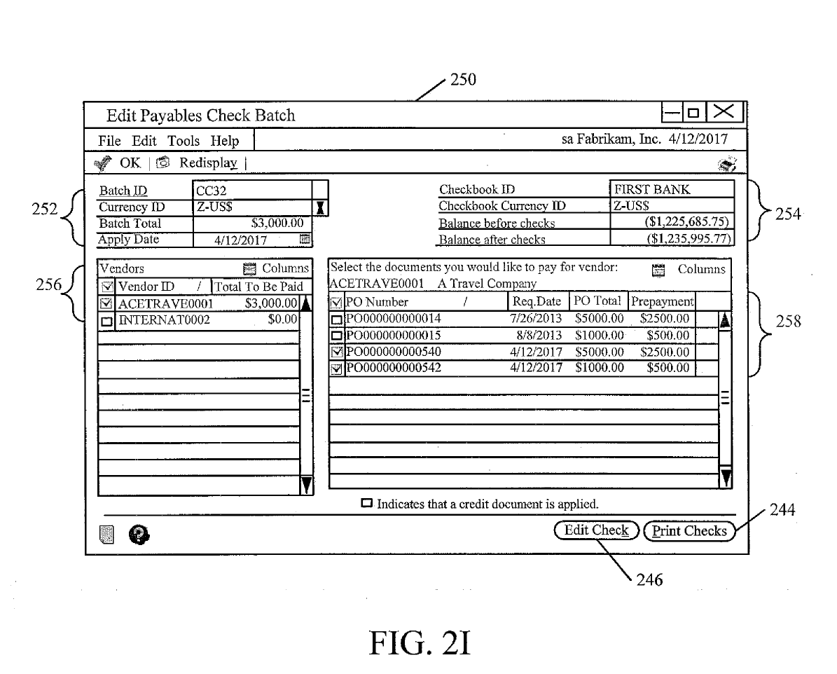

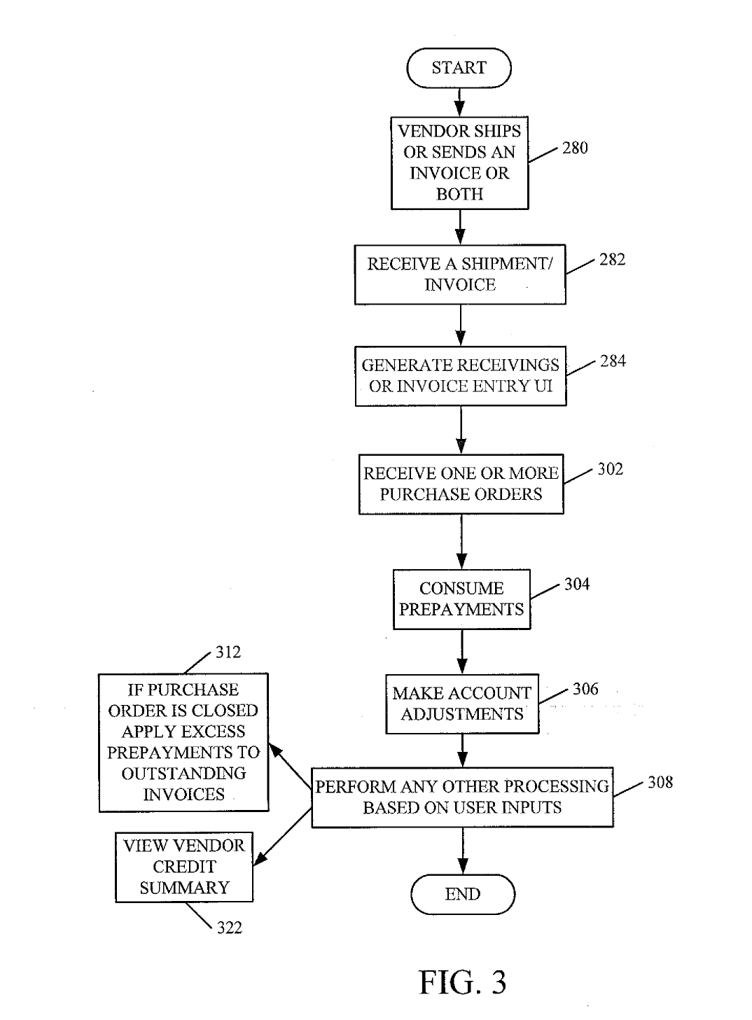

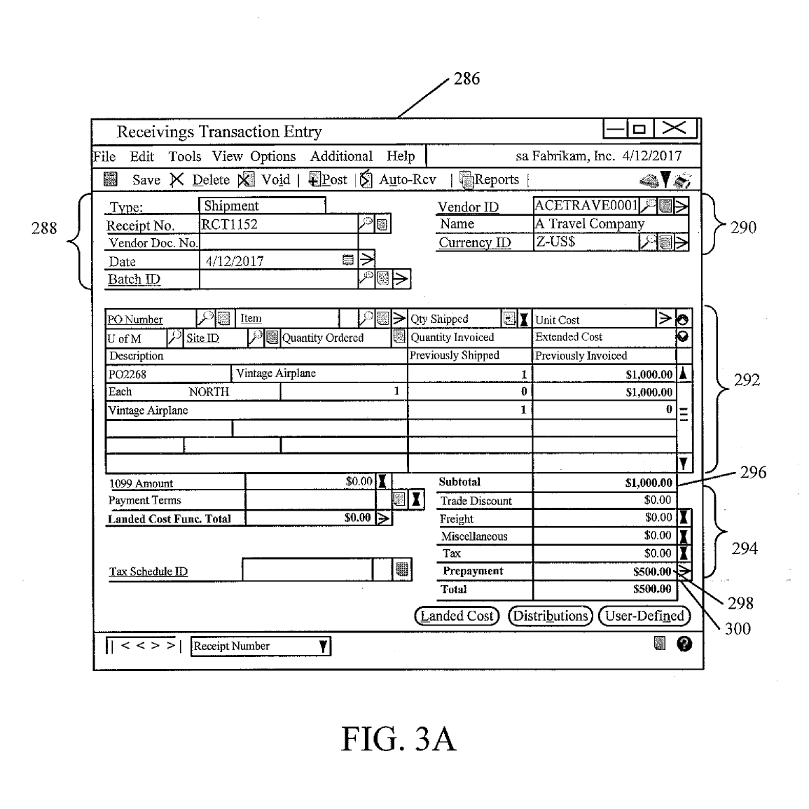

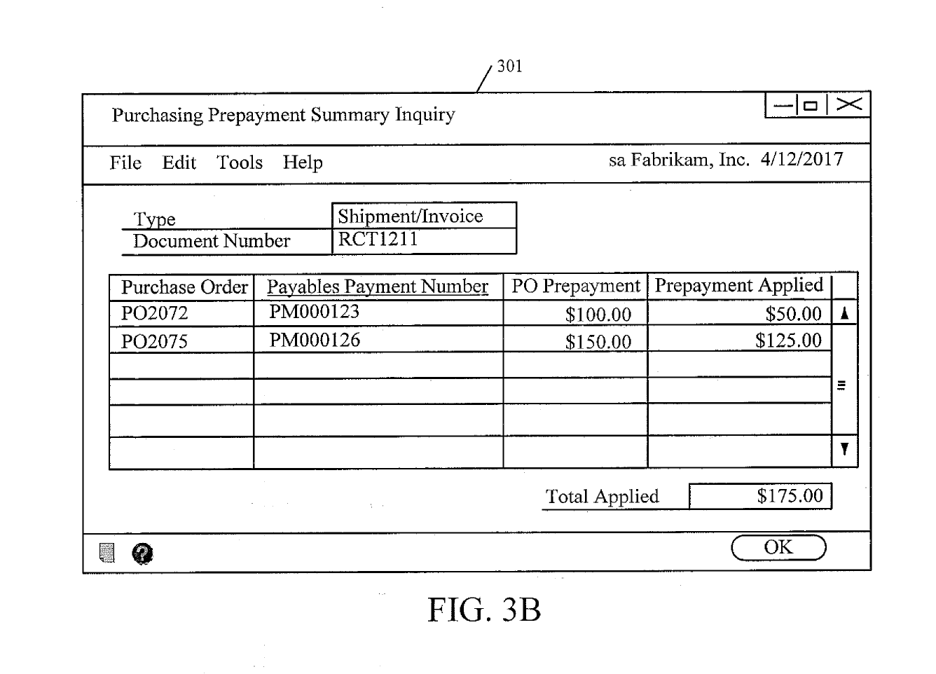

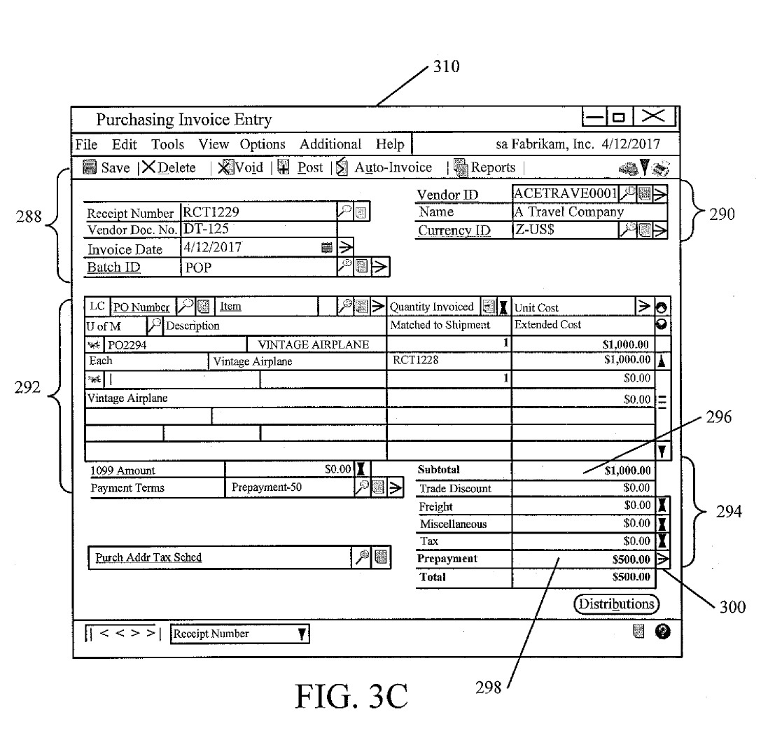

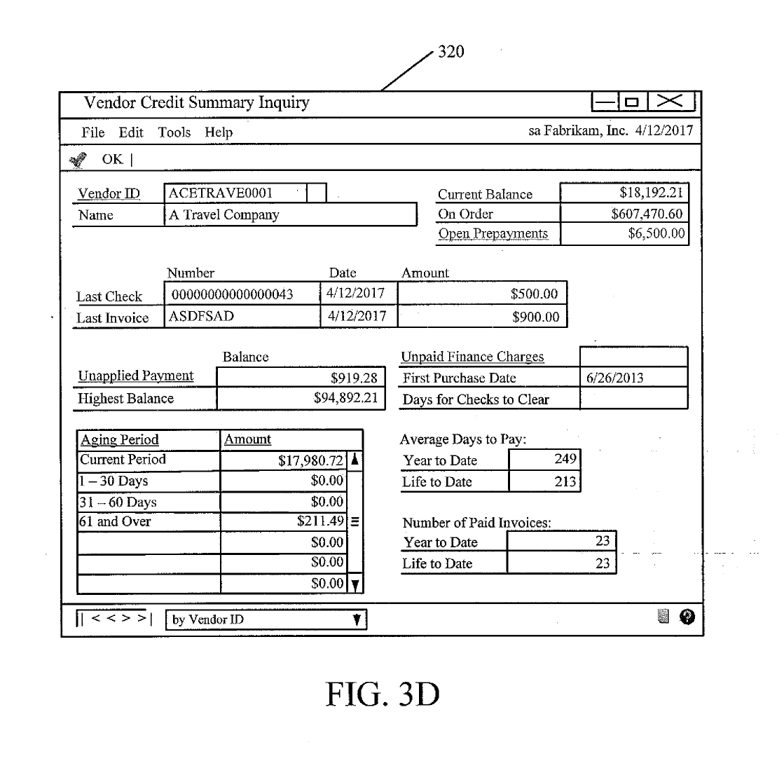

The overall operation of business system 100 is described below with respect to FIGS. 2 and 3. Briefly, however, by way of overview, user 116 uses purchase order processing component 106 to generate a purchase order which is to be sent to a vendor to purchase goods or services. Purchase order processing component 106 allows user 116 to also generate prepayment records 124 that are tied to purchase orders 122. When a shipment/invoice or invoice is received on a purchase order, payables management component 108 allows user 116 to consume any prepayments that were made on that purchase order, and that correspond to the shipment/invoice or invoice. The payables management component 108 then illustratively updates the accounts payable account 118, deferred prepayment account 120, and other business data records in data store 104.

FIG. 2 is a flow diagram illustrating one embodiment of the operation of business system 100 in generating a purchase order with a prepayment. In one embodiment, user 116 interacts with a suitable user interface display to request purchase order processing component 106 to set up a purchase order. Purchase order processing component 106 then generates a purchase order setup user interface to allow the user 116 to do that. Generating the user interface is indicated by block 140 in FIG. 2.

FIG. 2A shows one illustrative purchase order processing setup user interface display 142. Display 142 includes a first portion 144 that allows user 116 to input a purchase order number, a receipt number, to provide inputs to format the purchase order and designate a currency, as well as to provide document information and line identifier information, among other things.

User interface display 142 also includes a prepayment setup portion 146. Portion 146 includes user input mechanisms that allow a user to indicate that the purchase order being set up should accommodate prepayments. In the embodiment shown in FIG. 2A, this is done by providing a check box 148 that the user can check to enable prepayments corresponding to a given purchase order. The user 116 can also, in the embodiment shown in FIG. 2A, indicate whether paying the prepayment amount will be done manually. This is done, in one embodiment, by checking check box 150. Further, the user can set a password on the prepayment by typing the password into field 152, and the user can also designate an account from which the prepayment funds will be drawn, in field 154. Of course, the user input mechanisms in portion 146 of user interface display 142 are exemplary only. The user can interact with these mechanisms by using voice commands, using a point and click device (such as a mouse), by using keys on a keyboard or a virtual keyboard. Also, where the user interface display screen used to display user interface display 142 is a touch sensitive screen, the user can interact with the user input mechanisms in portion 146 using touch gestures, using a stylus, or in other ways. Receiving the user inputs setting up a purchase order to receive a prepayment is indicated by block 156 in FIG. 2.

Once the purchase order has been set up, and the user provides a suitable user input (such as by clicking the “OK” button 158) the setup selections are saved. The user can then navigate to a purchase order entry display, such as user interface display 160 shown in FIG. 2B. User interface display 160 provides user input mechanisms that allow a user to actually enter purchase order information into business system 100 using purchase order processing component 106. Generating the purchase order entry user interface is indicated by block 162 in FIG. 2. Because the user has enabled prepayments in section 146 in FIG. 2A, portion 168 in FIG. 2B appears and becomes usable. This will now be described in more detail.

In the embodiment shown in FIG. 2B, user interface display 160 includes identifying information portion 164 that allows the user to input purchase order identifying information. In one embodiment, that information includes a purchase order number, a buyer identifier, a purchase order date, a vendor identifier, a vendor name, and a currency designation. Similarly, user interface display 160 shows an embodiment where the user can also enter purchase order line items in line item portion 166. In the exemplary embodiment shown in FIG. 2B, line item portion 166 includes a description portion, a site identifier, a quantity ordered or canceled, and a unit cost or extended cost. User interface display 160 shows that the description is a vintage airplane, the quantity is 1, and the cost is $1000.00. The prepayment amount is illustrative of a 50% prepayment of the subtotal.

User interface display 160 also includes a prepayment portion 168 that allows the user to input a prepayment amount in field 170. In addition, when the user is viewing purchase order 160, after it has already been set up, the user can actuate prepayment expansion button 172 to view the details of the prepayment entered in field 170. Receiving the user inputs entering the purchase order information, and receiving entry of the prepayment amount of the purchase order in field 170, are indicated by blocks 174 and 176 in FIG. 2, respectively.

If the user actuates the prepayment expansion button 172, purchase order processing component 106 can generate a password entry user interface display, such as user interface display 178 shown in FIG. 2C. This will be generated where the user has entered a prepayment password on the setup screen (shown in FIG. 2A). The user can then enter the prepayment password in field 180 and actuate the OK button 182, where a password is necessary.

Purchase order processing component 106 then illustratively generates a prepayment information user interface display, such as user interface display 184 shown in FIG. 2D. User interface display 184 illustratively provides detailed information about the prepayment that is set out on the purchase order shown on user interface display 160 of FIG. 2B. In the embodiment shown in FIG. 2D, the information includes a prepayment account and description portion 186, a payment type and payment method portion 188, a check information portion 190 and an account and description portion 192. Of course, this is only an exemplary user interface display, and others could be generated as well.

FIGS. 2E-2G show a variety of different user interface displays 194, 196, and 198 that show different types of information that can be entered on display 184 of FIG. 2D. For instance, FIG. 2E shows that the prepayment account is entered in the prepayment account portion 186 and the payment type and payment method in portion 188 have been selected as a computer generated check.

The user interface display 196 shown in FIG. 2F is similar to that shown in FIG. 2E, except that the payment type has been changed to a manual payment. This means that a user must manually generate the check for the prepayment amount. User interface display 196 in FIG. 2F also shows that the bank, check number, date and payment number have been entered in portion 190.

User interface display 198 shown in FIG. 2G is similar to that shown in FIGS. 2E and 2F, except that the payment method has been changed to credit card in portion 188. User interface display 198 also shows that portion 190 now identifies the credit card information, instead of the bank, check number, etc . . .

Once the purchase order has been generated and entered, and the prepayment information has been entered, purchase order processing component 106 allows user 116 to actually make the prepayment so that it can be sent along with the purchase order (or separately), to a vendor. Purchase order processing component 106 first determines whether the prepayment process is to be performed manually or automatically. This is indicated by block 200 in FIG. 2. Recall that in setting up the purchase order (as shown in FIG. 2A) user 116 can indicate with user input mechanism 150 whether the prepayment is to be performed manually. If payment order processing component 106 determines that payment is to be made manually, then component 106 generates a user interface display to display the necessary prepayment information to user 116, so that the user 116 can make the manual payment. Generating the user interface display is indicated by block 202 in FIG. 2.

The particular display generated will depend on whether the user has selected (such as shown in FIGS. 2E-2G) whether the prepayment is to be made by check or credit card. If it is to be made by check, then purchase order processing component 106 displays the check information to the user so that the user can write a check. Determining how the payment is to be made is indicated by block 204, displaying the check information is indicated by block 206 and writing the check is indicated by block 208.

On the other hand, if payment order processing component 106 determines that the prepayment is to be made by credit card, it displays the credit card payment information to the user, as indicated by block 210. The user can then actuate a suitable user input mechanism in order to make the credit card payment. This is indicated by block 212. Once the payment has been made (either by writing a check or initiating a credit card payment), user 116 can then print out the purchase order for which the prepayment has just been made, or store it in business data store 104. When the purchase order is stored in data store 104, the corresponding prepayment information is also stored along with it. This is indicated by block 214 in FIG. 2. User 116 can then send the purchase order, along with the prepayment, to the vendor. This is indicated by block 216 in FIG. 2.

If, at block 200, payment order processing component 106 determines that the prepayment is to be made automatically (such as through a computer generated check), component 106 generates a suitable user interface display for automatic payment. This is indicated by block 218 in FIG. 2. One embodiment of such a user interface display is user interface display 220 shown in FIG. 2H. User interface display 220 includes a vendor and restrictions portion 222. Portion 222 allows the user to select a vendor identifier using dropdown menu 224 and also restrict the particular purchase orders for which prepayment is to be automatically generated. For instance, the user can illustratively select all purchase orders from the vendor identified in dropdown menu 224, or it can select specific purchase orders as restricted by the “from” and “to” fields 226 and 228 in FIG. 2H. Further, the user can input additional restrictions in field 230, such as Boolean restrictions or other restrictions. It can also be seen that user interface display 220 displays the particular bank and currency that is to be used on the check, in display portion 234. Receiving the user inputs identifying the vendor and other restrictions is indicated by block 236 in FIG. 2.

It should also be noted, in one embodiment, user interface display 220 allows user 116 to generate a batch of prepayments for the identified vendor. Field 238 allows the user to input or select a batch identifier and button 240 allows the user to build a batch of prepayments that are to be made to the vendor identified in the vendor identifier dropdown menu 224, as restricted by the restrictions in fields 226, 228, and 230. In doing this, once the user has input the vendor and other restrictions, the user can actuate the “build batch” button 240. This causes purchase order processing component 106 to search business data store 104, and specifically search for purchase orders 122 that match the vendor and restrictions input by the user in user interface display 220. When those matching purchase orders are identified, those with corresponding prepayments 124 are surfaced for display to the user. Identifying and displaying purchase orders with prepayments to build a batch is indicated by block 242 in FIG. 2.

Once a batch has been identified, user 116 can then simply print checks corresponding to each of the purchase orders with prepayments by actuating the print checks button 244. The user can also edit the checks by actuating the edit checks button 246, and the user can also edit the batch of checks by actuating button 248.

If the user actuates the edit check batch button 248, purchase order processing component 106 illustratively generates a suitable user interface display, such as display 250 shown in FIG. 2I, that allows the user to edit the batch of checks that are to be automatically generated for making prepayments. Purchase order processing component 106 (using user interface component 112) generates the exemplary user interface display 250 to identify the batch, currency and date, along with the bank and account information in portions 252 and 254 of user interface display 250. In addition, purchase order processing component 106 generates display 250 so that it identifies the particular vendors in vendor display portion 256 for which the purchase orders are being added to the batch. Further, user interface display 250 illustratively includes purchase order display portion 258 that displays all the purchase orders that correspond to the vendor and other restrictions input by the user on interface display 220 shown in FIG. 2H.

User interface display 250 illustratively provides user input mechanisms that allow user 116 to edit the batch of checks that are to be automatically generated. For instance, in vendor identifier portion 256, check boxes are provided that allow the user to check certain vendors for which prepayment checks are to be generated. Similarly, in the purchase order identifying portion 258, check boxes are also provided that allow the user to select certain purchase orders for which the prepayments are to be made.

In the embodiment shown, portion 256 also shows the total to be paid to each given vendor. Similarly, portion 258 shows the purchase order number, the required date of prepayment, the purchase order total, and the prepayment amount corresponding to each purchase order.

Once the user has edited the batch using user interface display 250, the user can again simply actuate the “print checks” button 244, or the user can edit each of the individual prepayment checks that are to be generated by actuating the “edit check” button 246. In any case, once all of the user's editing inputs have been received, purchase order processing component 106 automatically prints the prepayment checks for the batch of purchase orders that has been built. In one embodiment, a separate check is printed for the prepayment corresponding to each purchase order. Of course, this is exemplary only. In another embodiment, a single check may be generated for all prepayments due for a given vendor. Similarly, in another embodiment, individual checks can be generated for prepayments required for each line item of a purchase order. All of these embodiments are contemplated. Receiving any editing inputs is indicated by block 270 in FIG. 2, and automatically printing the checks is indicated by block 272 in FIG. 2. Once the checks are automatically printed, they can be sent, along with the purchase orders, to the vendors, as indicated by block 216.

In FIG. 2, after the purchase order and prepayment have been sent to the vendor, purchase order processing component 108 illustratively makes necessary account adjustments to the accounts stored in business data store 104. In one embodiment, this is done by posting the prepayment to deferred prepayment account 120 as an asset, instead of as a liability to the accounts payable account 118. Other account adjustments can be made as well.

After the purchase order and prepayment have been sent to the vendor, the vendor illustratively fills the purchase order and either sends an invoice to the customer, or sends the shipment to the customer, or sends both an invoice and the shipment to the customer. FIG. 3 is a flow diagram showing one embodiment of how payables management component 108 and purchase order processing component 106 interact to process invoices for shipments, as they are received, in order to account for any prepayments that have been made. First, the vendor ships or sends an invoice or both. This is indicated by block 280 in FIG. 3. Business system 100 then receives the shipment or invoice, or both, as indicated by block 282. In one embodiment, the invoice is an electronic invoice or it is converted to electronic form so that it can be recognized by payables management component 108. This can be done in a wide variety of ways, such as scanning the invoice into a recognizable form, such as receiving an electronic version of the invoice, etc. In any case, once payables management component 108 receives the invoice or an indication that the shipment has been received from the vendor, it generates a receivings transaction entry user interface display. This is indicated by block 284 in FIG. 3.

FIG. 3A illustrates one embodiment of a receivings transaction entry user interface display 286. Purchase order processing component 106 illustratively generates user interface display 286 when the customer has received a shipment from the vendor. Display 286 identifies the shipment/invoice by receipt number, vendor document number, date and batch ID in portion 288, and it also identifies the vendor by vendor ID, name and the currency used in portion 290. Of course, these items are given by way of example only and different identifiers or other items can be used as well.

User interface display 286 also illustratively identifies the particular purchase order that the shipment corresponds to. This is provided in purchase order identifying portion 292. It can be seen that portion 292 illustratively includes a description that has a purchase order number, a written description, a quantity ordered, a quantity invoiced and shipped, as well as a cost portion. It can also be seen that user interface display 286 illustratively includes a total cost portion 294 that shows the subtotal of the invoice for the order in field 296. Portion 294 also includes a variety of other potential costs, such as trade discounts, freight, miscellaneous costs, taxes, etc. Further, portion 294 includes prepayment field 298 that shows the amount of the prepayment that was made on this particular purchase order. In one embodiment, the amount of the prepayment consumed on a shipment/invoice or invoice cannot exceed the Subtotal minus Trade Discount.

In the embodiment illustrated, field 298 also includes expansion button 300 that, when actuated by a user, allows the user to see the details of the prepayment that has already been made corresponding to this purchase order. This is described with respect to FIG. 3B below.

In order to generate user interface display 286, purchase order processing component 106 receives the invoice (which has a purchase order identified thereon). Component 108 then searches data store 104 for the specific purchase order or purchase orders listed on the invoice in the shipment details, and identifies the prepayments from prepayment records 124 corresponding to those purchase orders. Purchase order processing component 106 uses this information to generate user interface display 286, and to specifically identify the prepayment amount in field 298 of the prepayment that has already been made for the identified purchase order. Identifying the one or more purchase orders in data store 104 that have corresponding prepayments is indicated by block 302 in FIG. 3. It can be seen that user interface display 286 shows that the prepayment is consumed against the invoice subtotal in field 296. Consuming the prepayments is indicated by block 304 in FIG. 3.

Referring again to FIG. 3, once the prepayment has been consumed against the shipping receipt, payables management component 108 illustratively makes desired account adjustments to the accounts in business data store 104. This is indicated by block 306 in FIG. 3. For instance, the appropriate deferred prepayment amount can be backed out of deferred prepayment account 120 and any vendor summary information is updated for the amount of prepayment that has been consumed.

At block 284, instead of receiving a shipment and receipt, an invoice is received. Thus, another suitable user interface display, such as user interface display 310 in FIG. 3C, can be generated. User interface display 310 is similar to user interface display 286 in FIG. 3A, and similar items are similarly numbered. However, it can be seen that an invoice has been entered as the vendor document number in portion 288. The invoice is matched to a purchase order number and to a shipment in portion 292. However, user interface display 310 also shows the prepayment amount in field 298 and allows the user to consume that against the invoiced amount in field 296 to obtain a total remaining amount. In one embodiment, the amount of prepayment consumed cannot exceed the subtotal minus trade discount. In the example shown it would consume the full prepayment. However, if the example were modified so the quantity was 2 for an extended cost of $2000 ($1000 each) and the prepayment was $1200 and only one item is received/invoiced then the prepayment amount shown would be $1000.

Once the prepayments are identified on corresponding purchase orders, and are consumed against invoices or receipts on shipments, and once the account adjustments are made as indicated by block 306, it should be noted that business system 100 can perform other processing based on user inputs as well. This is indicated by block 308. As examples, it may happen that a given purchase order 122 has a corresponding prepayment 124 that is never consumed against an invoice on that purchase order. If the purchase order is closed, and there is some amount of prepayment still available, then payables management component 108 can generate a user interface display so that the user can apply that remaining prepayment amount against other invoices or shipping receipts for the same vendor. This is indicated by block 312 in FIG. 3. In addition, user 116 may wish to view a vendor credit summary showing available prepayment balances and invoice balances of a given vendor. In that case, system 100 can generate a suitable user interface display, such as user interface display 320 shown in FIG. 3D. User interface display 320 allows the user to identify a vendor. It then shows summary information for that vendor, such as a current balance for all purchase orders, an amount for items that have been ordered from the vendor, an open prepayments balance that shows unapplied prepayments, an aged accounts portion that shows accounts by age, and other information that may be helpful to user 116. Viewing a vendor credit summary is indicated by block 322 in FIG. 3.

It can thus be seen that, in one embodiment, the user can input a prepayment amount and tie it to a purchase order when the purchase order is entered. The prepayment can then be posted to a deferred prepayment account as an asset, instead of to an accounts payable account as a liability. When an invoice is received on the purchase order, the prepayment is automatically identified as corresponding to the purchase order and it is applied against the invoice so that the prepayment can be consumed first, before the accounts payable account is increased. This can be done either when a shipment is received along with an invoice or when an invoice is received for the purchase order. The user can also designate prepayment to be made either manually or automatically, and the user can generate a batch of prepayments for purchase orders. Similarly, the user can apply excess prepayments to outstanding invoices once a purchase order has been closed.

Further, the purchase order can be viewed as a type of transaction record. The prepayments can be viewed as pre-allocation amounts. Thus, pre-allocation amounts can be entered on a transaction record and stored so that when the transaction record is subsequently retrieved from storage and displayed, the pre-allocation information is displayed along with it.

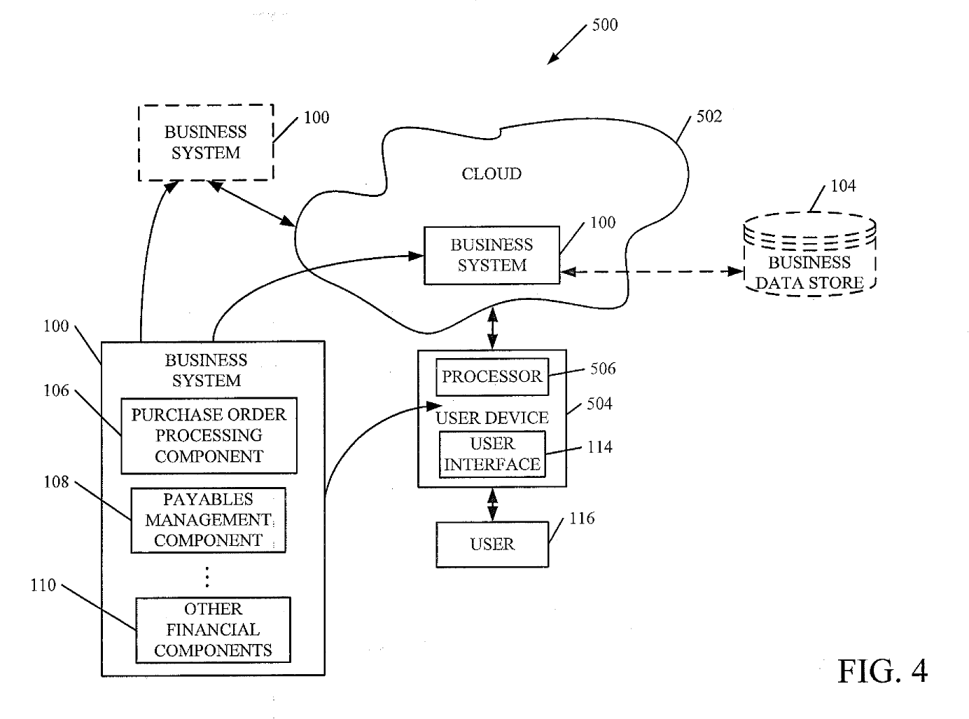

FIG. 4 is a block diagram of system 100, shown in various architectures, including cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of system 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

The embodiment shown in FIG. 4, specifically shows that business system 100 is located in cloud 502 (which can be public, private, or a combination where portions are public while others are private). Therefore, user 116 uses a user device 504 to access those systems through cloud 502.

FIG. 4 also depicts another embodiment of a cloud architecture. FIG. 4 shows that it is also contemplated that some elements of business system 100 are disposed in cloud 502 while others are not. By way of example, data store 110 can be disposed outside of cloud 502, and accessed through cloud 502. In another embodiment, some or all of the components of system 100 are also outside of cloud 502. Regardless of where they are located, they can be accessed directly by device 504, through a network (either a wide area network or a local area network), they can be hosted at a remote site by a service, or they can be provided as a service through a cloud or accessed by a connection service that resides in the cloud. FIG. 4 further shows that some or all of the portions of system 100 can be located on device 504. All of these architectures are contemplated herein.

It will also be noted that system 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

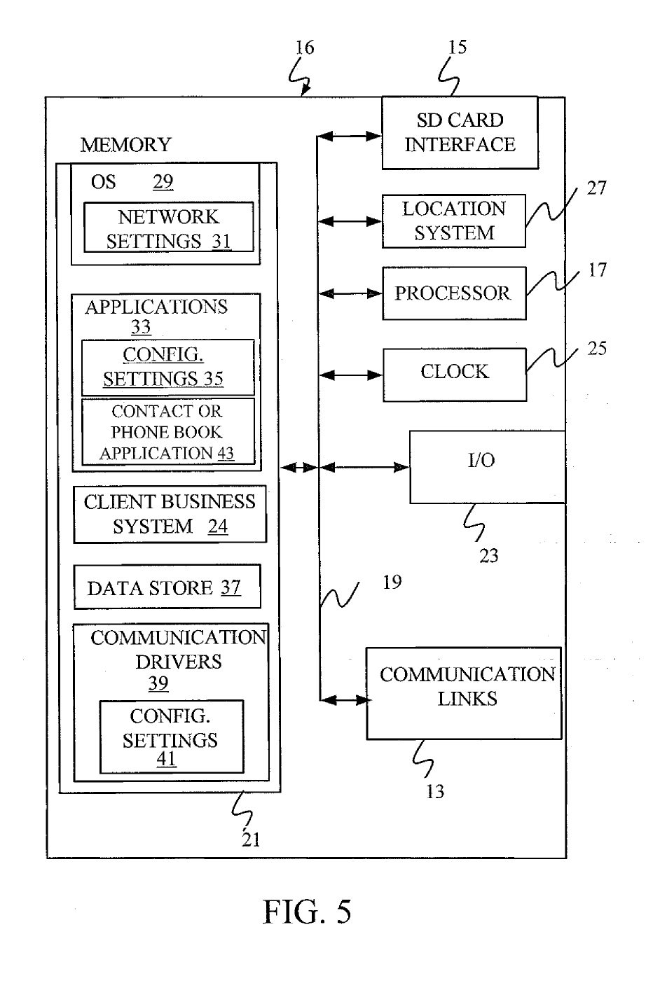

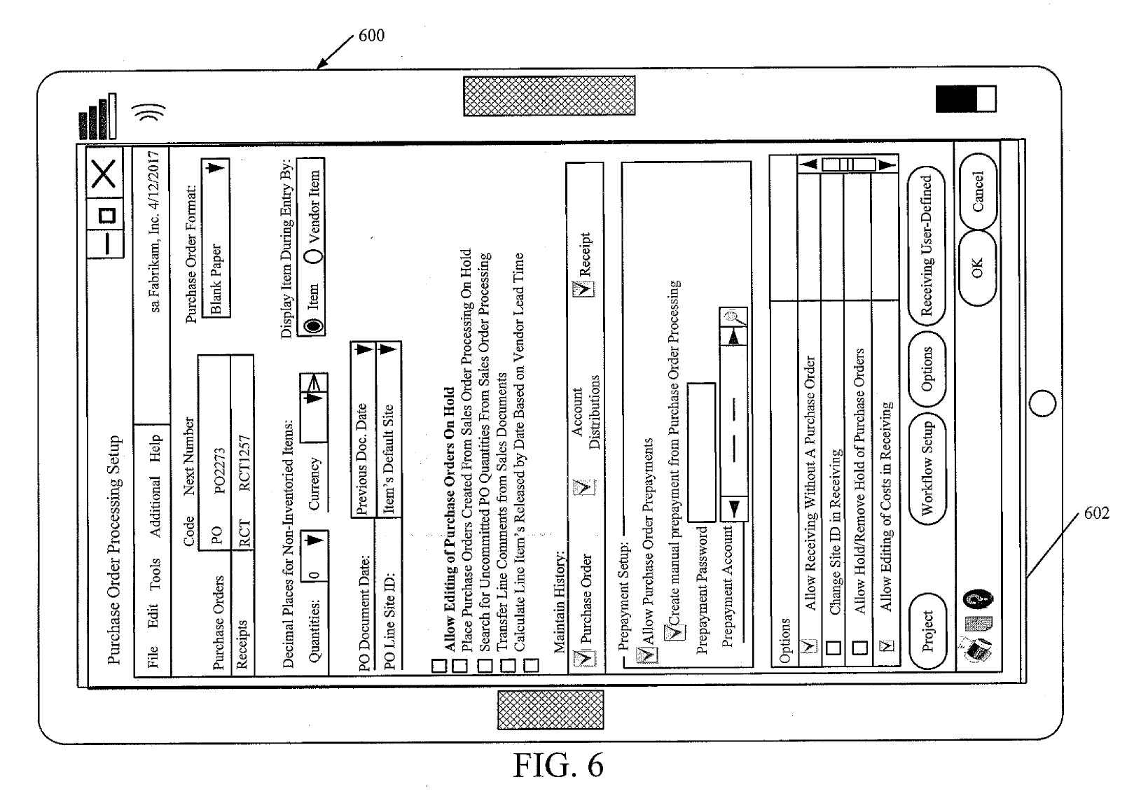

FIG. 5 is a simplified block diagram of one illustrative embodiment of a handheld or mobile computing device that can be used as a user's or client's hand held device 16, in which the present system (or parts of it) can be deployed. FIGS. 6-9 are examples of handheld or mobile devices.

FIG. 5 provides a general block diagram of the components of a client device 16 that can run components of system 100 or that interacts with system 100, or both. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1Xrtt, and Short Message Service, which are wireless services used to provide cellular access to a network, as well as 802.11 and 802.11b (Wi-Fi) protocols, and Bluetooth protocol, which provide local wireless connections to networks.

Under other embodiments, applications or systems (like system 100) are received on a removable Secure Digital (SD) card that is connected to a SD card interface 15. SD card interface 15 and communication links 13 communicate with a processor 17 (which can also embody processors 102 from FIG. 1) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. System 100 or the items in data store 104, for example, can reside in memory 21. Similarly, device 16 can have a client business system 24 which can run various business applications or embody parts or all of system 100. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

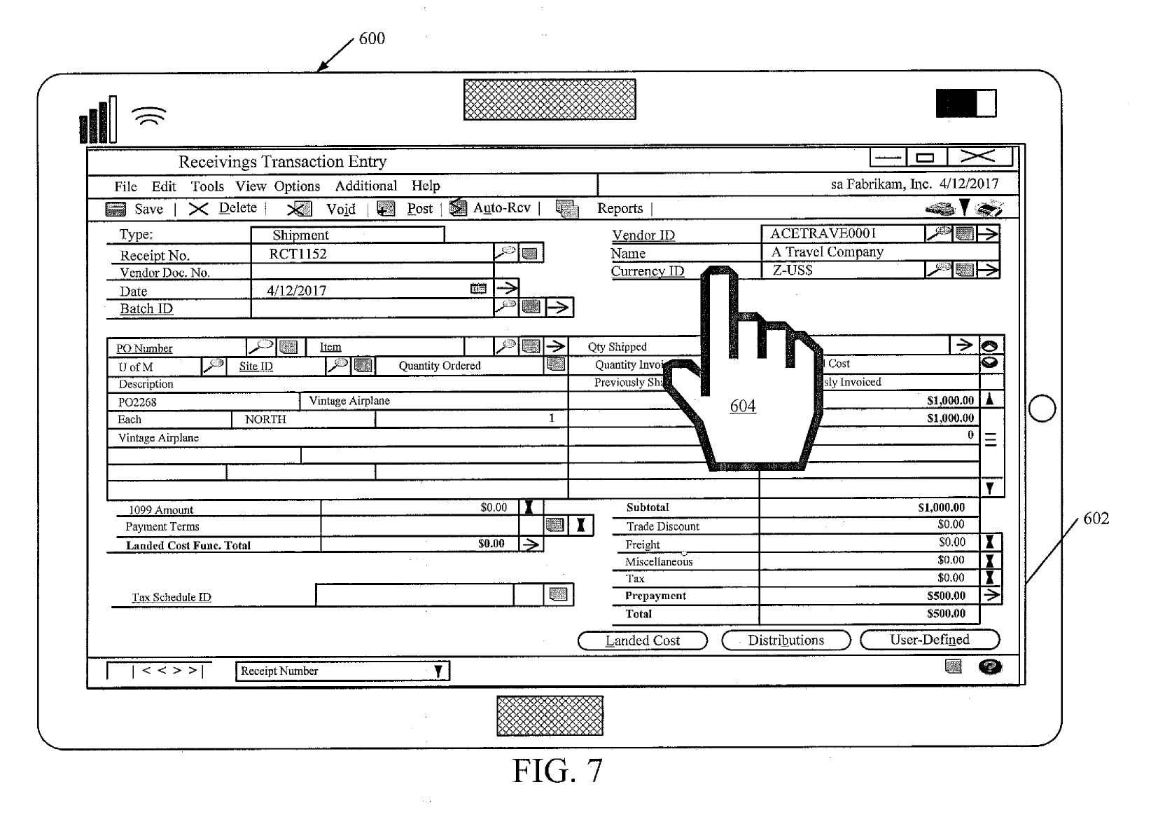

FIGS. 6 and 7 show one embodiment in which device 16 is a tablet computer 600. Computer 600 is shown with display screen 602. Screen 602 can be a touch screen (so touch gestures from a user's finger 604 can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

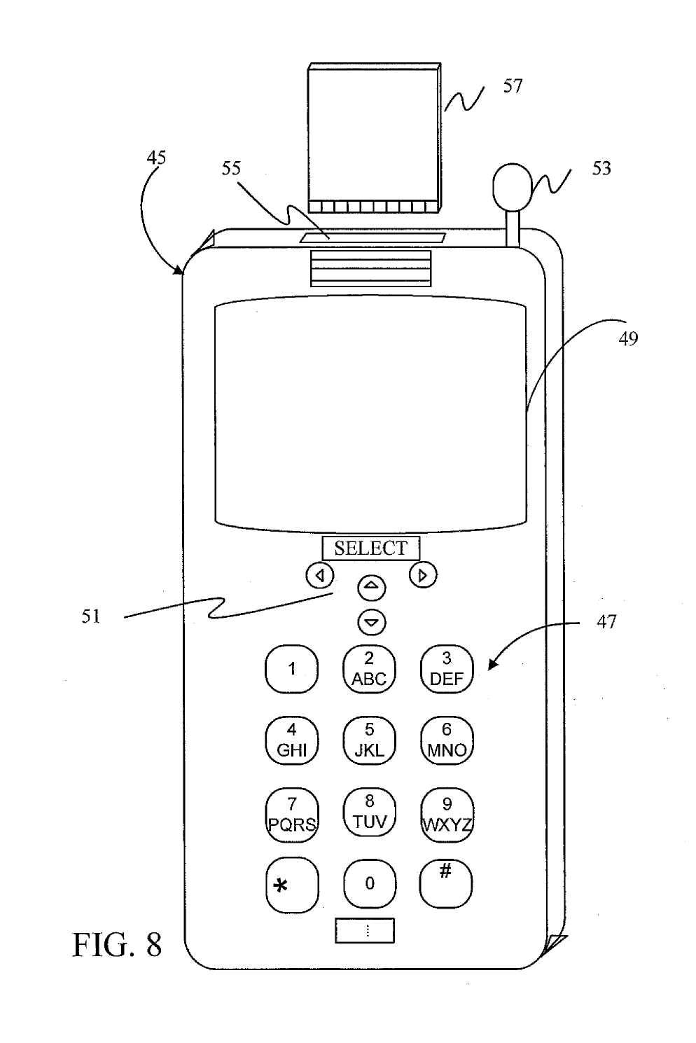

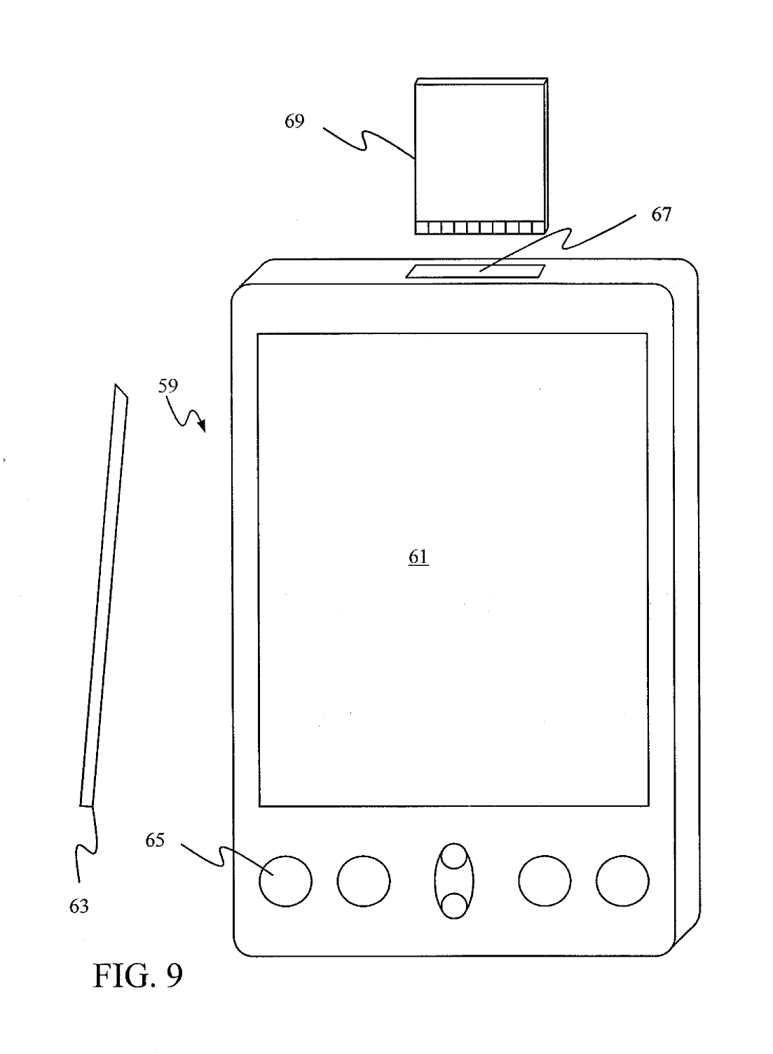

FIGS. 8 and 9 provide additional examples of devices 16 that can be used, although others can be used as well. In FIG. 8, a smart phone or mobile phone 45 is provided as the device 16. Phone 45 includes a set of keypads 47 for dialing phone numbers, a display 49 capable of displaying images including application images, icons, web pages, photographs, and video, and control buttons 51 for selecting items shown on the display. The phone includes an antenna 53 for receiving cellular phone signals such as General Packet Radio Service (GPRS) and 1Xrtt, and Short Message Service (SMS) signals. In some embodiments, phone 45 also includes a Secure Digital (SD) card slot 55 that accepts a SD card 57.

The mobile device of FIG. 9 is a personal digital assistant (PDA) 59 or a multimedia player or a tablet computing device, etc. (hereinafter referred to as PDA 59). PDA 59 includes an inductive screen 61 that senses the position of a stylus 63 (or other pointers, such as a user's finger) when the stylus is positioned over the screen. This allows the user to select, highlight, and move items on the screen as well as draw and write. PDA 59 also includes a number of user input keys or buttons (such as button 65) which allow the user to scroll through menu options or other display options which are displayed on display 61, and allow the user to change applications or select user input functions, without contacting display 61. Although not shown, PDA 59 can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections. In one embodiment, mobile device 59 also includes a SD card slot 67 that accepts a SD card 69.

Note that other forms of the devices 16 are possible.

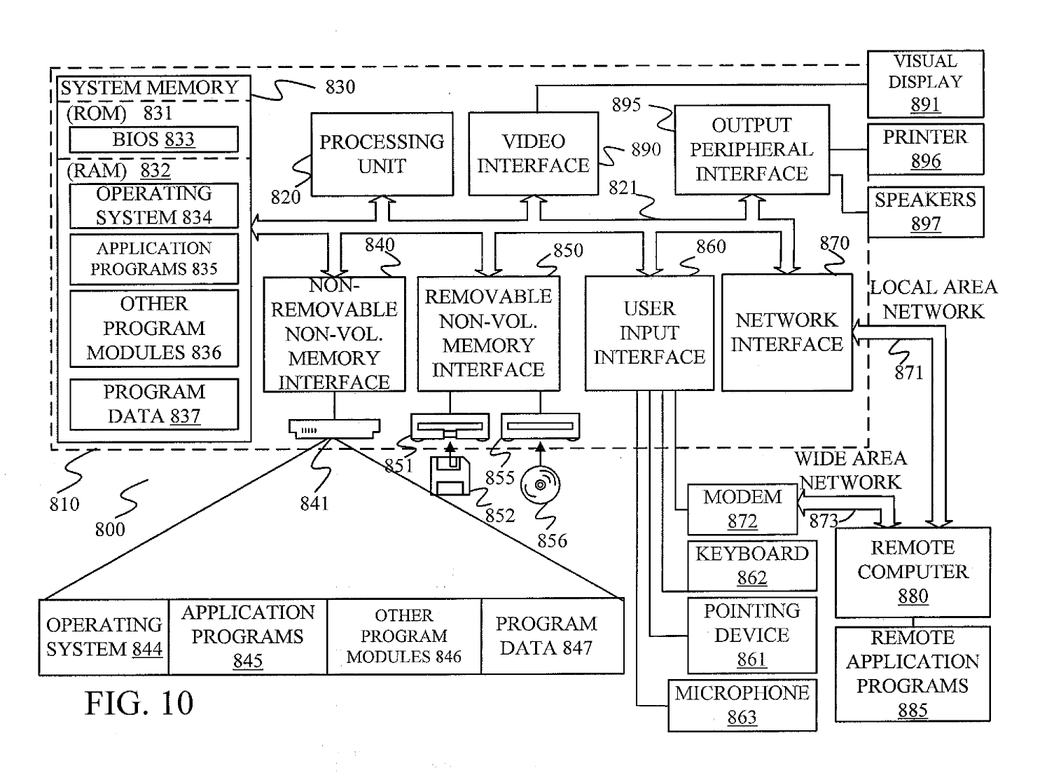

FIG. 10 is one embodiment of a computing environment in which system 100 (for example) can be deployed. With reference to FIG. 10, an exemplary system for implementing some embodiments includes a general-purpose computing device in the form of a computer 810. Components of computer 810 may include, but are not limited to, a processing unit 820 (which can comprise processor 102), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 10.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 10 illustrates operating system 834, application programs 835, other program modules 836, and program data 837.

The computer 810 may also include other removable/non-removable volatile/nonvolatile computer storage media. By way of example only, FIG. 10 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

The drives and their associated computer storage media discussed above and illustrated in FIG. 10, provide storage of computer readable instructions, data structures, program modules and other data for the computer 810. In FIG. 10, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 8 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 10 illustrates remote application programs 885 as residing on remote computer 880. It will be appreciated that the network connections shown are exemplary and other means of establishing a communications link between the computers may be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method of tracking pre-allocated amounts in a transaction, comprising:
generating a transaction record entry user interface displaying a transaction record with a transaction detail entry user input mechanism and a pre-allocation entry user input mechanism;
receiving transaction detail user inputs through the transaction detail entry user input mechanism to enter transaction detail information on the transaction record;
receiving pre-allocation user inputs through the pre-allocation entry user input mechanism to enter pre-allocation information on the transaction record; and
storing the transaction record with the pre-allocation information wherein retrieval of the transaction record from storage and display of the transaction record also displays the pre-allocation information.

2. A computer-implemented method of tracking prepayment amounts in a transaction, comprising:
generating a purchase order entry user interface displaying a purchase order with a purchase order entry user input mechanism and a prepayment entry user input mechanism;
receiving purchase order user inputs through the purchase order entry user input mechanism to enter purchase order information on the purchase order;
receiving prepayment user inputs through the prepayment entry user input mechanism to enter prepayment information on the purchase order; and
storing the purchase order with the prepayment information wherein retrieval of the purchase order from storage and display of the purchase order also displays the prepayment information.

3. The computer-implemented method of claim 2 and further comprising:
generating the prepayment as indicated by the prepayment information.

4. The computer-implemented method of claim 3 and further comprising:
automatically adjusting a deferred prepayment account based on an amount of the prepayment generated.

5. The computer-implemented method of claim 4 and further comprising:
automatically sending the generated prepayment and the purchase order to a vendor.

6. The computer-implemented method of claim 3 wherein generating the prepayment comprises:
accessing a payment form indicator on the purchase order to determine whether the prepayment is to be generated automatically; and
if so, generating an automatic payables user interface with a purchase order search user input mechanism.

7. The computer-implemented method of claim 6 wherein generating the prepayment further comprises:
receiving search criteria through the purchase order search user input mechanism;
identifying purchase orders with prepayments based on the search criteria; and
automatically printing prepayment checks corresponding to the identified purchase orders.

8. The computer-implemented method of claim 7 wherein identifying purchase orders comprises:
building a batch of purchase orders that meet the search criteria and that have prepayments; and
generating a batch edit user interface with edit user input mechanisms that receive edit user inputs to edit the batch of purchase orders.

9. The computer-implemented method of claim 8 wherein the edit user input mechanisms receive selection user inputs selecting individual purchase orders in the batch, for which prepayments are to be made.

10. The computer-implemented method of claim 3 and, before generating the purchase order entry user interface, further comprising:
generating a purchase order setup user interface display with a purchase order setup user input mechanism and a prepayment setup user input mechanism;
receiving purchase order setup user inputs through the purchase order setup user input mechanism setting up the purchase order; and
receiving a prepayment setup user input through the prepayment setup user input mechanism to set up the purchase order to allow a prepayment.

11. The computer-implemented method of claim 10 wherein generating the purchase order setup user interface with the prepayment setup user input mechanism comprises:
generating the purchase order setup user interface with a payment form user input mechanism that receives a payment form user input to indicate whether the prepayment is to be made manually or automatically.

12. The computer-implemented method of claim 5 and further comprising:
receiving a payment due record from the vendor, the payment due record comprising a shipment record or an invoice;
identifying a purchase order corresponding to the payment due record.

13. The computer-implemented method of claim 12 and further comprising:
identifying any prepayments made for the purchase order corresponding to the payment due record; and
consuming the prepayments made for the purchase order to obtain a remaining balance.

14. The computer-implemented method of claim 13 and further comprising:
automatically adjusting an accounts payable account based on the remaining balance; and
automatically adjusting the deferred payment account based on the prepayments consumed.

15. The computer-implemented method of claim 3 and further comprising:
receiving user search inputs to identify closed purchase orders with unconsumed prepayment balances for a given vendor;
searching the storage for closed purchase orders with unconsumed prepayment balances for the given vendor based on the user search inputs; and
consuming the unconsumed prepayment balances against other invoices for the given vendor.

16. A business system, comprising:
a purchase order processing component generating purchase order user interface displays for setting up and entering purchase orders that have corresponding prepayments;
a payables management component generating payables user interface displays for paying invoices from vendors, the payables management component receiving a given invoice and retrieving a given purchase order related to the given invoice and generating a given payables user interface display showing consumption of the prepayments on the given invoice to obtain a remaining balance for the given invoice and adjusting an accounts payable account based on the remaining balance; and
a computer processor being a functional component of the business system and activated by the purchase order processing component and the payables management component to facilitate generating the purchase order user interface displays and the payables user interface displays, retrieving the given purchase order and consuming the prepayments.

17. The business system of claim 16 and further comprising:
a data store storing the purchase orders along with prepayment information corresponding to the purchase orders, the payables management component generating the given payables user interface display by searching the data store for the given purchase order and retrieving the given purchase order along with corresponding prepayment information including a prepayment amount.

18. The business system of claim 16 wherein the purchase order processing component generates a payables user interface display with user input mechanisms that receive search criteria to identify purchase orders with corresponding prepayments and generates a batch of prepayment checks for the identified purchase orders.

19. The business system of claim 18 wherein the purchase order processing system generates the payables user interface display with edit user input mechanisms that receive user edit inputs editing the batch of prepayment checks.

20. The business system of claim 16 wherein the payables management component identifies closed purchase orders with prepayment balances, for a given vendor, and generates a user interface display to apply the prepayment balances to outstanding invoices for the given vendor.
